(19) United States
(12) Patent Application Publication
(10) Pub. No.: US 2013/0333999 A1
(43) Pub. Date: Dec. 19, 2013

(54) TRANSMITTING APPARATUS OF PRINTER

(71) Applicant: PING-FANG TSAI, Tu-Cheng (TW)

(72) Inventor: PING-FANG TSAI, Tu-Cheng (TW)

(73) Assignee: HON HAI PRECISION INDUSTRY CO., LTD., Tu-Cheng (TW)

(21) Appl. No.: 13/552,754

(22) Filed: Jul. 19, 2012

(30) Foreign Application Priority Data
Jun. 13, 2012 (TW) 101121218

(51) Int. Cl. F16D 13/04

(52) U.S. Cl. 192/66.1

(57) ABSTRACT

A transmitting apparatus of a printer, includes an active shaft and a sliding bush. A positioning post is located on the active shaft. A sliding bush is movably mounted on the active shaft. The sliding bush defines a first positioning slot and a second positioning slot. The sliding bush includes an active gear. The sliding bush is configured to move on the active shaft to selectively receive the positioning post in the first positioning slot or the second positioning slot to mesh the active gear with different transmitting gears.

### BACKGROUND

1. Technical Field

The present disclosure relates to transmitting apparatus, and more particularly to a transmitting apparatus of a printer.

2. Description of Related Art

A printer often equips a plurality of transmitting apparatus to transmit print medium, such as paper or a plastic sheet therein. For example, a plurality of rollers are often mounted in different positions to transmit print media and move it forwards. Each of the plurality of rollers needs a motor to rotate it. So the printer often has a plurality of motors mounted therein, which is high-cost and hard to maintain.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded and isometric view of a transmitting apparatus of a printer of an embodiment.

FIG. 2 is an assembled view of the transmitting apparatus of FIG. 1.

FIG. 3 is another assembled view of the transmitting apparatus of FIG. 1.

FIG. 4 is another more assembled view of the transmitting apparatus of FIG. 1 in a different state of assembly.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

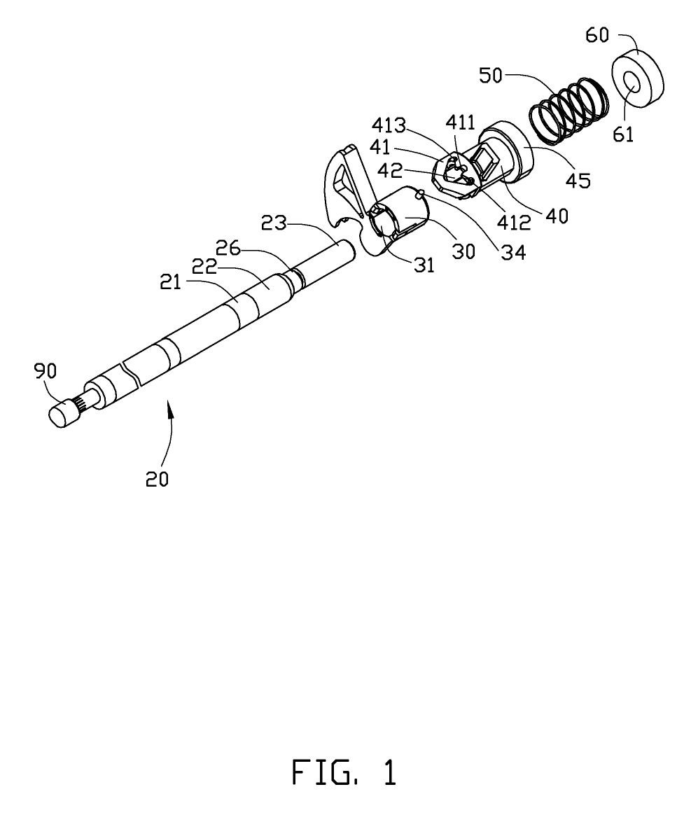

FIG. 1 shows a transmitting apparatus of a printer in accordance with an embodiment. The transmitting apparatus includes an active shaft 20, a fixing bush 30, a sliding bush 40, a spring 50, a stopper 60, a first transmitting gear 71, a second transmitting gear 72, and a third transmitting gear 73. The first transmitting gear 71, the second transmitting gear 72, and the third transmitting gear 73 are linked to different rollers (not shown).

The active shaft 20 is connected to a motor 90, and driven to rotate by the motor 90. The active shaft 20 includes a bush mounting portion 21, a bush sliding portion 22, and a stopper mounting portion 23. In cross section, the bush mounting portion 21, the bush sliding portion 22, and the stopper mounting portion 23 are not circular. A bush rotating portion 26 is located between the bush sliding portion 22 and the stopper mounting portion 23.

The fixing bush 30 can be mounted on the bush mounting portion 21 of the active shaft 20. The fixing bush 30 defines a non-circular fixing hole 31 corresponding to the bush mounting portion 21. A positioning post 34 protrudes from an outer surface of fixing bush 30.

The sliding bush 40 can be slidably set on the bush sliding portion 22 of the active shaft 20. The sliding bush 40 defines a non-circular set hole (not shown) corresponding to the bush sliding portion 22. A size of the bush rotating portion 26 is smaller than a size of the set hole. The sliding bush 40 can slide to the bush rotating portion 26, and can rotate on the rotating portion 26.

The sliding bush 40 includes a positioning piece 41 which is adjacent to the fixing bush 30. The positioning piece 41 defines an opening 42, a first positioning slot 411, a second positioning slot 412, and a third positioning slot 413. All of the slots 411, 412, and 413 communicate with the opening 42. Lengths of the first positioning slot 411, the second positioning slot 412, and the third positioning slot 413 are all different. The sliding bush 40 is equipped with an active gear 46.

The stopper 60 defines a non-circular mounting hole 61 corresponding to the stopper mounting portion 23 of the active shaft 20.

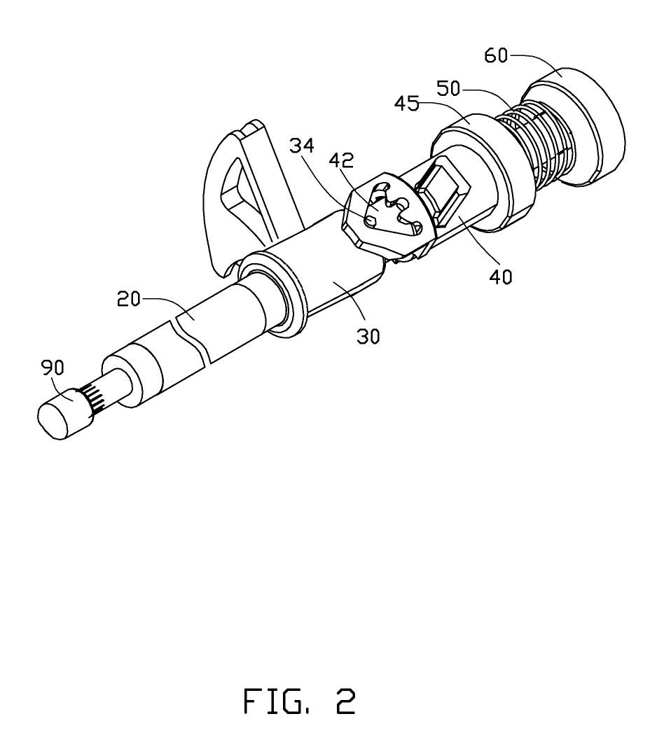

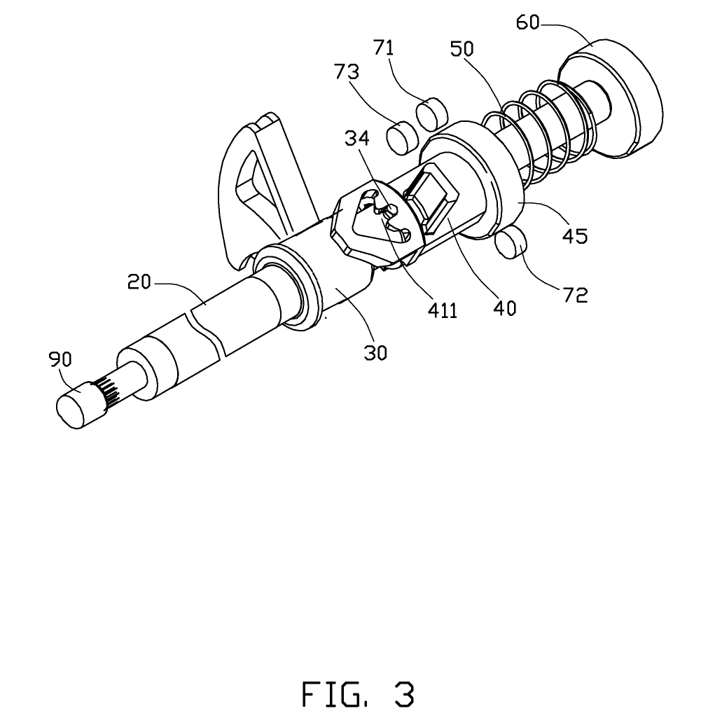

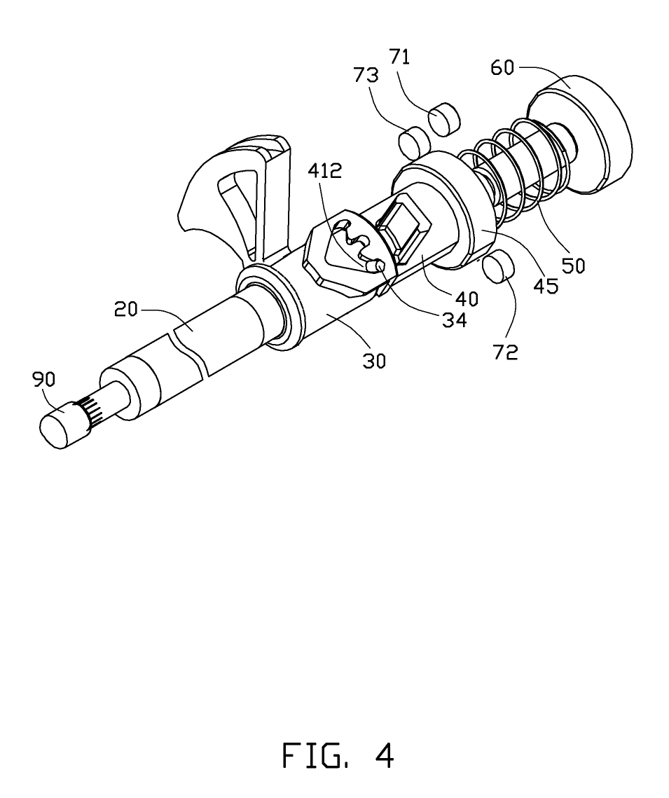

FIGS. 1 to 4 show the assembly of the transmitting apparatus. The bush mounting portion 21 of the active shaft 20 is mounted in the fixing hole 31 of the fixing bush 30 to mount the fixing bush 30 onto the active shaft 20. The bush sliding portion 22 is slidably inserted in the set hole of the sliding bush 40 to slidably mount the sliding bush 40 on the active shaft 20. The positioning post 34 of the fixing bush 30 is received in the opening 42 of the sliding bush 40. Then, the spring 50 is retained on the active shaft 20. One end of the spring 50 abuts the sliding bush 40. The stopper mounting portion 23 of the active shaft 20 is mounted in the mounting hole 61 to mount the stopper 60 on the active shaft 20. The other end of the spring 50 abuts the stopper 60. The spring 50 is compressed to constantly impose an elastic force on the sliding bush 40. Finally, the first transmitting gear 71, the second transmitting gear 72, and the third transmitting gear 73 are staggered and located adjacent the active gear 45.

To transmitting a paper in the printer, the sliding bush 40 slides on the active shaft 20 from the bush sliding portion 22 to the bush rotating portion 26. The sliding bush 40 rotates on the rotating portion 26 to align the first positioning slot 41 with the positioning post 34. Then the sliding bush 40 is released and the spring 50 rebounds to push sliding bush 40 back to the bush sliding portion 22. The positioning post 34 of the fixing bush 30 is received in the first positioning slot 41. At this position, the active gear 45 meshes with the first passive gear 71. The motor 90 drives the active shaft 20 to rotate the sliding bush 40. The active gear 45 drives the first passive gear 71 to rotate the roller to move the paper.

After the paper is advanced by the first passive gear 71, the motor 90 stops rotating. The sliding bush 40 slides again on the active shaft 20 from the bush sliding portion 22 to the bush rotating portion 26. The sliding bush 40 rotates on the rotating portion 26 to align the second positioning slot 42 with the positioning post 34. Then the sliding bush 40 is released and the spring 50 rebounds to push sliding bush 40 back to the bush sliding portion 22. The positioning post 34 of the fixing bush 30 is received in the second positioning slot 42. At this position, the active gear 45 meshes with the second transmitting gear 72. The motor 90 rotates the active shaft 20 to bring the sliding bush 40 into rotation. The active gear 45 drives the second transmitting gear 72 to rotate the roller to further advance the paper.

After the paper is passed on by the second transmitting gear 72, the motor 90 stops rotating. The sliding bush 40 slides again on the active shaft 20 from the bush sliding portion 22 to the bush rotating portion 26. The sliding bush 40 rotates on the rotating portion 26 to align the third positioning slot 43 with the positioning post 34. Then the sliding bush 40 is released and the spring 50 rebounds to push sliding bush 40 back to the bush sliding portion 22. The positioning post 34 of the fixing bush 30 is received in the third positioning slot 43. At this position, the active gear 45 meshes with the third transmitting gear 73. The motor 90 rotates the active shaft 20 to rotate the sliding bush 40. The active gear 45 rotates the third transmitting gear 73 to rotate the roller rotate to move the paper on.

In the transmitting apparatus, the active gear 45 first rotates the first transmitting gear 71, then the second transmitting gear 72, and then the third transmitting gear 73. The first transmitting gear 71, the second transmitting gear 72, and the third transmitting gear 73 act one after the other to move the paper through the printer. Therefore, only one motor 90 is required to drive a plurality of gears and rollers.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A transmitting apparatus of a printer, comprising:
an active shaft, a positioning post located on the active shaft;
a sliding bush movably mounted on the active shaft, the sliding bush defining a first positioning slot and a second positioning slot, the sliding bush comprising an active gear;
wherein the sliding bush is configured to move on the active shaft to selectively receive the positioning post in the first positioning slot or in the second positioning slot to mesh the active gear with different transmitting gears.

2. The transmitting apparatus of claim 1, wherein the active shaft comprises a bush sliding portion and a bush rotating portion, the sliding bush is configured to slide between the bush sliding portion and the bush rotating portion; when the sliding bush is in the bush sliding portion, the sliding bush rotates together with the active shaft; when the sliding bush is the bush rotating portion, the sliding bush is configured to rotate to align the first positioning slot or the second positioning slot with the positioning post.

3. The transmitting apparatus of claim 1, wherein the sliding bush comprises a positioning piece, the positioning piece defines an opening, the first positioning slot and the second positioning slot are defined in the positioning piece and communicate with the opening, and the positioning post is adapted to insert in the opening.

4. The transmitting apparatus of claim 1, wherein the active shaft comprises a bush mounting portion, a fixing bush defines a fixing hole, cross sections of the bush mounting portion and the fixing hole are non-circle, and the bush mounting portion is mounted in the fixing hole to mount the fixing bush on the active shaft, and the positioning post is protruded on an outer surface of fixing bush.

5. The transmitting apparatus of claim 1, wherein a stopper is mounted on the active shaft, and a spring is elastically compressed between the stopper and the sliding bush.

6. The transmitting apparatus of claim 1, wherein lengths of the first positioning slot and the second positioning slot are different.

7. The transmitting apparatus of claim 1, wherein the transmitting gears are staggered and located adjacent the active gear.

8. A transmitting apparatus of a printer, comprising:
an active shaft driven by a motor;
a sliding bush movably mounted on the active shaft, the sliding bush comprising an active gear;
a first transmitting gear and a second transmitting gear staggered and located adjacent the active gear;
wherein the sliding bush is configured to located on different positions of the active shaft to mesh the active gear with the first transmitting gear or with the second transmitting gear.

9. The transmitting apparatus of claim 8, wherein a positioning post is located on the active shaft, the sliding bush defines a first positioning slot and a second positioning slot, the positioning post is adapted to locate in the first positioning slot to mesh the active gear with the first transmitting gear, and the positioning post is adapted to located in the second positioning slot to mesh the active gear with the second transmitting gear.

10. The transmitting apparatus of claim 9, wherein the active shaft comprises a bush sliding portion and a bush rotating portion, the sliding bush is configured to slide between the bush sliding portion and the bush rotating portion; when the sliding bush is in the bush sliding portion, the sliding bush rotates together with the active shaft; when the sliding bush is in the bush rotating portion, the sliding bush is configured to rotate to align the first positioning slot or the second positioning slot with the positioning post.

11. The transmitting apparatus of claim 9, wherein the sliding bush comprises a positioning piece, the positioning piece defines an opening, the first positioning slot and the second positioning slot are defined in the positioning piece and communicate with the opening, and the positioning post is adapted to insert in the opening.

12. The transmitting apparatus of claim 9, wherein the active shaft comprises a bush mounting portion, a fixing bush defines a fixing hole, cross sections of the bush mounting portion and the fixing hole are non-circular, and the bush mounting portion is mounted in the fixing hole to mount the fixing bush on the active shaft, and the positioning post is protruded on an outer surface of fixing bush.

13. The transmitting apparatus of claim 9, wherein lengths of the first positioning slot and the second positioning slot are different.

14. The transmitting apparatus of claim 8, wherein a stopper is mounted on the active shaft, and a spring is elastically compressed between the stopper and the sliding bush.
